(19) United States
(12) Patent Application Publication
(10) Pub. No.: US 2026/0336493 A1
(43) Pub. Date: Oct. 29, 2026

(54) VEHICLE

(71) Applicant: KAWASAKI MOTORS, LTD., Akashi-shi (JP)

(72) Inventor: Kenta TAKADA, Akashi-shi, Hyogo (JP)

(73) Assignee: KAWASAKI MOTORS, LTD., Akashi-shi (JP)

(21) Appl. No.: 19/646,658

(22) Filed: Apr. 14, 2026

(30) Foreign Application Priority Data
Apr. 28, 2025 (JP) 2025-074457

(51) Int. Cl. B60N 2/75; B60N 2/01; B60R 22/34

(52) U.S. Cl. CPC B60N 2/77; B60N 2/01; B60R 22/34; B60R 2022/3402

(57) ABSTRACT

A vehicle includes a vehicle body, a front seat supported by the vehicle body, a rear seat supported by the vehicle body rearward from the front seat, a front center console, and a rear center console separate from the front center console and extending rearward from a rear end of the front center console. The vehicle body includes an intermediate floor located between the front seat and the rear seat in a front-rear direction. The rear center consol protrudes upward from the intermediate floor and extends rearward from a position frontward from a middle position of the intermediate floor in the front-rear direction.

### CROSS-REFERENCE TO RELATED APPLICATION

The present application claims priority to Japanese Patent Application No. 2025-074457 filed on Apr. 28, 2025, the content of which is incorporated herein by reference.

### BACKGROUND

### Technical Field

The present disclosure relates to a vehicle.

### Description of the Background

Patent Literature 1 describes an integral center console including a rear center console and a front center console integral with each other.

### CITATION LIST

### Patent Literature

Patent Literature 1: U.S. Pat. No. 10,427,578

### BRIEF SUMMARY

For the rear center console and the front center console integral with each other with the technique described in Patent Literature 1, the rear center console alone may be difficult to replace.

One or more aspects of the present disclosure are directed to a technique for easy replacement of a rear console.

A vehicle includes a vehicle body, a front seat supported by the vehicle body, a rear seat supported by the vehicle body rearward from the front seat, a front center console, and a rear center console separate from the front center console and extending rearward from a rear end of the front center console. The vehicle body includes an intermediate floor located between the front seat and the rear seat in a front-rear direction. The rear center console protrudes upward from the intermediate floor and extends rearward from a position frontward from a middle position of the intermediate floor in the front-rear direction.

A method for manufacturing a vehicle includes preparing a vehicle body including an intermediate floor, a front seat, and a front center console as common components, and preparing a first set and a second set as selective component sets. The first set includes a bench rear seat including a bench seat bottom and a first rear center console. The second set includes separate rear seats including a right rear seat and a left rear seat and a second rear center console. The method includes attaching the front seat, the front center console, the bench rear seat, and the first rear center console to the vehicle body to cause the first rear center console to extend rearward from a rear end of the front center console and to protrude upward from the intermediate floor to manufacture a vehicle with a rear bench seat, and attaching the front seat, the front center console, the separate rear seats, and the second rear center console to the vehicle body to cause the second rear center console to extend rearward from the rear end of the front center console and to protrude upward from the intermediate floor to manufacture a vehicle with rear separate seats.

This vehicle allows easy replacement of the rear console.

This method for manufacturing the vehicle allows easy replacement of the console based on the rear seat being either a bench seat or a separate seat.

### BRIEF DESCRIPTION OF DRAWINGS

FIG. 1 is a perspective view of a vehicle according to a first embodiment.

FIG. 2 is a perspective view of a rear seat of the vehicle and the peripheral portions of the rear seat.

FIG. 3 is a perspective view of a rear portion of the vehicle.

FIG. 4 is a partial cross-sectional view taken along line IV-IV in FIG. 1.

FIG. 5 is a perspective view of a rear center console.

FIG. 6 is a cross-sectional view of a connecting portion between a front center console and the rear center console.

FIG. 7 is a perspective view of the rear center console.

FIG. 8 is a perspective view of a rear-seat base and a back panel.

FIG. 9 is a partial perspective view of a vehicle according to a second embodiment.

FIG. 10 is a cross-sectional view taken along line X-X in FIG. 9.

FIG. 11 is a partial perspective view of the vehicle.

FIG. 12 is a perspective view of a rear center console.

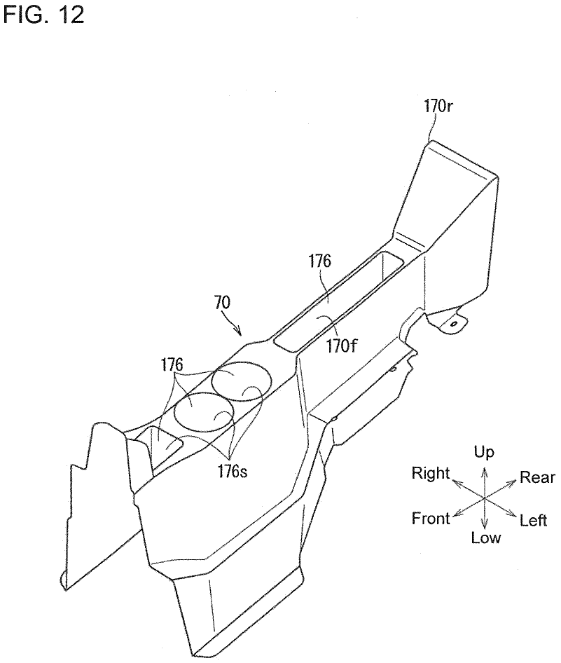

FIG. 13 is a flowchart of a method for manufacturing a vehicle.

### DETAILED DESCRIPTION

### First Embodiment

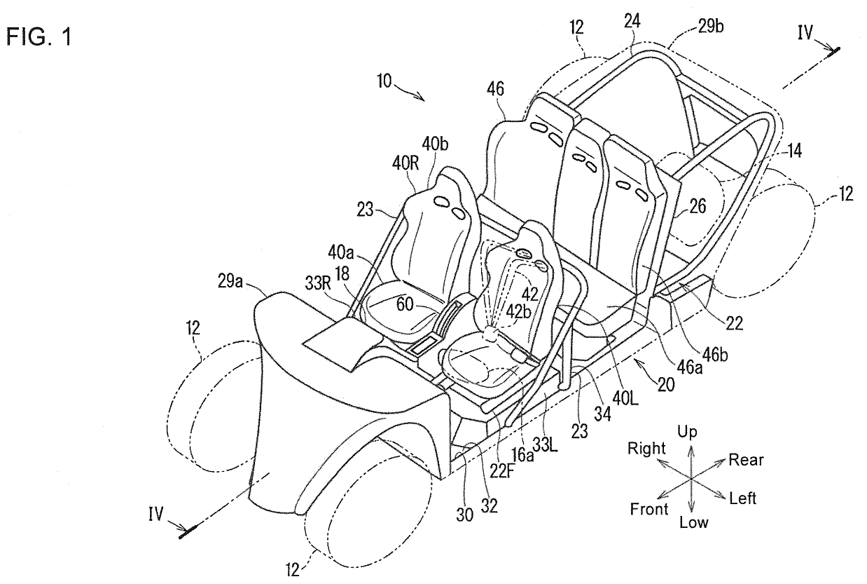

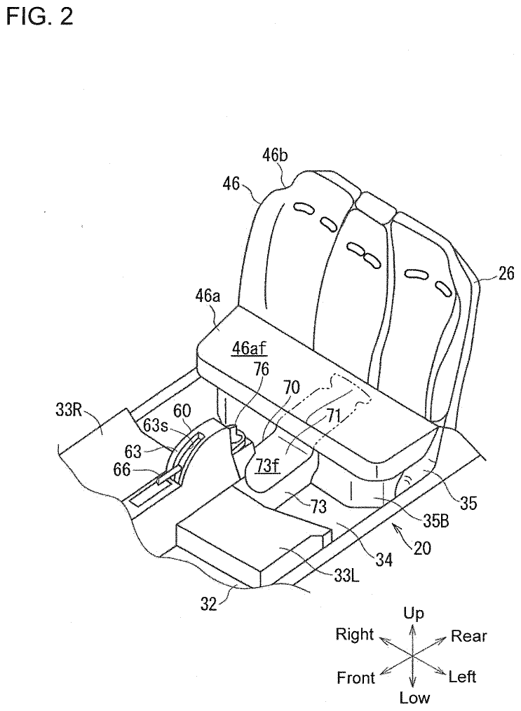

A vehicle according to a first embodiment will be described below. FIG. 1 is a perspective view of a vehicle 10. FIG. 2 is a perspective view of a rear seat 46 of the vehicle 10 and the peripheral portions of the rear seat 46. In FIG. 2, front seats 40R and 40L are not shown.

In the examples described below, the traveling direction of the vehicle 10 may be referred to as front, the direction opposite to the traveling direction as rear, the direction in which the traveling surface is located as low, and the direction opposite to the direction in which the traveling surface is located as up. The traveling surface is, for example, the ground or a road. The right and left may be referenced with the vehicle facing forward on the traveling surface. The right-left direction is the width direction of the vehicle.

The vehicle 10 is a conveyance that travels on the traveling surface. The vehicle 10 may be, for example, an off-road vehicle. The off-road vehicle may be a versatile compact vehicle that is more suitable for off-road driving than for public-road driving at high speeds.

The off-road vehicle includes, for example, a side-by-side vehicle. The side-by-side vehicle is, for example, a compact vehicle for all-terrain travel and in which passengers can sit next to each other. The side-by-side vehicle may be, for example, a multipurpose off-highway utility vehicle (MOHUV) as defined by ANSI/OPEI B71.9-2016, or a recreational off-highway vehicle as defined by ANSI/ROHVA 1-2016. In the present embodiment, the off-road vehicle includes the front seats 40R and 40L and the rear seat 46.

The vehicle 10 may be a passenger transport vehicle intended for traveling at low speeds in a limited area.

The limited area may be, for example, a limited community area, a private road, or private land (e.g., a golf course or a park). The limited community area is an area for local residents. The community area includes, for example, multiple houses and public facilities (e.g., schools or hospitals), in which vehicles not intended for public road travel are permitted to travel at low speeds. The low speeds refer to speeds with an upper limit of, for example, 20 to 30 mph. The vehicle 10 includes a personal transport vehicle (PTV) defined by ANSI/ILTVA Z135 and a golf cart defined by ANSI/ILTVA Z130.1. The vehicle 10 also includes a personal transportation electric vehicle.

The vehicle 10 includes a vehicle body 20, the front seats 40R and 40L, the rear seat 46, a front center console 60, and a rear center console 70.

The vehicle body 20 is a support structure that supports the components of the vehicle 10 or supports the occupants or cargo. The vehicle body 20 includes, for example, a frame 22 and a floor 30.

The frame 22 includes, for example, multiple elongated members that are joined together. The elongated members are, for example, metal members. The elongated members may be straight or curved. The elongated members may be pipes, plates, or members with a U-shaped cross section. The multiple elongated members may be joined together by, for example, welding or screwing.

The frame 22, including the multiple elongated members joined together, can extend under the floor 30.

The frame 22 may include a frame protruding from the floor 30. For example, the frame 22 may include an additional front frame 23. The additional front frame 23 protrudes upward from the floor 30 behind the front seats 40R and 40L. The additional front frame 23 may support, for example, front-seat seatbelt retractors behind backrests 40b of the front seats 40R and 40L. The front-seat seatbelt retractors can store seatbelts 42 for the front seats 40R and 40L in a manner extendable and retractable.

The frame 22 may include a rear frame 24 located behind the rear seat 46. The rear frame 24 may support a backrest 46b of the rear seat 46. The rear frame 24 located behind the rear seat 46 may support a driving system 14.

The floor 30 is at the bottom of the passenger space. The floor 30 includes surfaces for supporting the feet of the occupants in the vehicle or for the occupants to place their feet when they ride or exit the vehicle. The floor 30 includes a plate extending horizontally. The floor 30 may be a floor board.

In the present embodiment, the vehicle body includes the frame 22 and the floor 30 combined together. The vehicle body may be monocoque.

The floor 30 includes a front floor 32 and an intermediate floor 34.

The front floor 32 extends in front of the front seats 40R and 40L in the front-rear direction. The front floor 32 extends horizontally. The occupants of the front seats 40R and 40L can place their feet on the front floor 32.

The intermediate floor 34 is located between the front seats 40R and 40L and the rear seat 46 in the front-rear direction. The intermediate floor 34 extends horizontally. The occupants of the rear seat 46 can place their feet on the intermediate floor 34.

The floor 30 may include front-seat bases 33R and 33L protruding upward from the front floor 32 and the intermediate floor 34 between the front floor 32 and the intermediate floor 34.

The floor 30 has the front-seat base 33L on the left and the front-seat base 33R on the right. The front-seat base 33R and the front-seat base 33L are spaced from each other in the width direction of the vehicle. A space receiving the front center console 60 is defined between the front-seat base 33R and the front-seat base 33L.

The floor 30 may include a rear-seat base 35 located behind the intermediate floor 34. The rear-seat base 35 protrudes upward from the intermediate floor 34. The rear-seat base 35 is elongated in the width direction of the vehicle.

The vehicle body 20 may include a back panel 26 behind the rear seat 46. The back panel 26 stands upward from the rear end of the rear-seat base 35. The back panel 26 may be tilted rearward.

The vehicle body 20 may include wheels 12, the driving system 14, and a steering system.

The wheels 12 are rotatably supported on, for example, the right and left of the front and the rear of the vehicle body 20. The wheels 12 may be supported by the vehicle body 20 with a suspension system. Any number of wheels 12 may be used. For example, the wheels 12 may include a single front wheel 12.

For the off-road vehicle 10, the wheels 12 may include low-pressure tires. Low-pressure tires may be referred to as balloon tires. Low-pressure tires are filled at an upper limit air pressure of, for example, 40 kPa or less. Low-pressure tires deform in response to road surface irregularities, increasing the area of contact with the ground surface. This can improve the off-road capability of the vehicle 10 as compared with vehicles with high-pressure tires.

The driving system 14 causes the vehicle 10 to travel. The driving system 14 is supported by the frame 22. For example, the driving system 14 is supported by the rear frame 24. The driving system 14 includes, for example, a motor. The motor may be an internal combustion engine or an electric motor. For example, the rotational shaft of the motor is connected to the shafts of the rear wheels 12 directly or with gears. The rotational driving force of the motor is transmitted to the rear wheels 12, allowing the vehicle 10 to travel. The rotational driving force of the driving system 14 may be transmitted to the front wheels 12. For example, the rotational driving force of the driving system 14 may be transmitted to the front wheels 12 through a drive shaft.

When the rotational driving force of the driving system 14 is transmitted to the front and rear wheels 12, the off-road capability of the vehicle 10 improves.

The steering system controls the traveling operations of the vehicle 10. The traveling operations include, for example, the travel, stop, speed, and traveling direction of the vehicle 10.

The steering system includes, for example, a steering wheel 16a located frontward from the front seats 40R and 40L. The steering wheel 16a is rotatably supported by a steering shaft. The steering wheel 16a is operated to rotate the front wheels 12 about steering axes. The front wheels 12 rotate about the steering axes to change the traveling direction of the vehicle 10.

An instrument panel 18 may be installed frontward from the steering wheel 16a. The instrument panel 18 incorporates, for example, a speedometer and a battery level gauge.

The steering system may include control pedals. The control pedals may include, for example, a brake pedal and an accelerator pedal. The starting, accelerating, decelerating, and stopping can be controlled by adjusting the degree of pressing the pedals.

The vehicle 10 may include covers 29a and 29b. The cover 29a covers, for example, the portion of the vehicle body 20 located frontward from the instrument panel 18. The left and right portions of the cover 29a are wheel housings covering the front wheels 12. The cover 29b covers, for example, the rear frame 24. The driving system 14 is housed in the cover 29b. The cover 29b may include a cargo compartment definer forming a cargo compartment.

The vehicle 10 may include doors covering the outer left and right of the front seats 40L and 40R and the front floor 32. The vehicle 10 may include doors covering the outer left and right of the rear seat 46 and the intermediate floor 34. The vehicle 10 may include a roof covering the front seats 40L and 40R and the rear seat 46 from above. The roof may be supported at a position spaced upward from the floor 30 by posts standing from the vehicle body 20.

The front seats 40R and 40L are located rearward from the steering wheel 16a in the front-rear direction. The front seats 40R and 40L are, for example, in the frontmost row in the vehicle body 20. The front seats 40R and 40L may include a right front seat 40R and a left front seat 40L.

In the present embodiment, the left front seat 40L is located in a left portion of the vehicle body 20. The left front seat 40L is located directly behind the steering wheel 16a. The left front seat 40L is the driver seat.

The left front seat 40L may include a seat bottom 40a and a backrest 40b. The seat bottom 40a supports the occupant from below. The occupant can sit on the seat bottom 40a. The backrest 40b protrudes upward from the seat bottom 40a behind the seat bottom 40a. The occupant sitting on the seat bottom 40a can lean back on the backrest 40b. The backrest 40b supports the occupant's back from the rear.

The right front seat 40R is on the right of the left front seat 40L. The right front seat 40R is a passenger seat. The left front seat 40L and the right front seat 40R are spaced from each other in the width direction of the vehicle. A space for receiving the front center console 60 is defined between the left front seat 40L and the right front seat 40R.

Similarly to the left front seat 40L, the right front seat 40R may include a seat bottom 40a and a backrest 40b.

The left front seat 40L and the right front seat 40R are supported by the vehicle body 20. For example, the frame 22 is located in the front-seat bases 33R and 33L. Right and left front-seat mounting frames 22F extend on the top panels of the front-seat bases 33R and 33L and are fixed to the frame 22 in the front-seat bases 33R and 33L. The right front seat 40R and the left front seat 40L are fixed respectively to the right and left front-seat mounting frames 22F. The left front seat 40L and the right front seat 40R are thus supported by the vehicle body 20.

The front seats 40R and 40L are each equipped with the seatbelt 42. The seatbelt 42 includes a shoulder belt and a waist belt. The shoulder belt is extended from, for example, the front-seat seatbelt retractor in a retractable manner. The front-seat seatbelt retractor is supported by the additional front frame 23. The waist belt is supported at both outer positions of the seat bottom 40a. The shoulder belt and the waist belt are detachably connected to each other with a buckle 42b.

The seatbelt 42 may have any number of fixing points. For example, the seatbelt 42 may be a four-point seatbelt.

The rear seat 46 is supported by the vehicle body 20 rearward from the front seats 40R and 40L. The front seats 40R and 40L are spaced from the rear seat 46 to allow the occupants to place their legs. The rear seat 46 is located, for example, rearward and upward from the intermediate floor 34. The rear seat 46 is located frontward from the back panel 26.

The rear seat 46 may include a bench seat bottom 46a and the backrest 46b. The bench seat bottom 46a supports the occupants from below. The bench seat bottom 46a has a bench seat surface 46af extending in the width direction of the vehicle. The bench seat surface 46af is wide enough to allow multiple occupants to sit side by side. For example, the bench seat bottom 46a may be wide enough to allow three occupants to sit side by side.

The bench seat surface 46af may be, for example, at least 1 m wide or at least 1.2 m wide. For example, the bench seat surface 46af may have a width that is at least 80 percent of the total width of the vehicle body 20.

The backrest 46b protrudes upward from the bench seat bottom 46a behind the bench seat bottom 46a. The occupant sitting on the bench seat bottom 46a can lean back on the backrest 46b. The backrest 46b supports the occupant's back from the rear. The backrest 46b may be as wide as the bench seat bottom 46a. The backrest 40b may be divided into multiple sections.

The vehicle may further include other seats behind the rear seat 46. For example, the vehicle may include three rows of seats arranged in the front-rear direction.

The front center console 60 overlaps the front seats 40R and 40L in the front-rear direction. The front center console 60 is located near the middle position in the width direction of the vehicle, or for example, at the middle position in the width direction of the vehicle. In the present embodiment, the front center console 60 is located between the right front seat 40R and the left front seat 40L.

The front end of the front center console 60 may be continuous with a middle portion of the instrument panel 18. For example, the middle portion of the instrument panel 18 may protrude rearward, and the front center console 60 may be continuous with the rear end of the protruding portion.

The rear center console 70 is separate from the front center console 60. The rear center console 70 extends further rearward from the rear end of the front center console 60. The rear center console 70 protrudes upward from the intermediate floor 34. The rear center console 70 extends rearward from a position frontward from the middle position of the intermediate floor 34 in the front-rear direction. More specifically, the boundary between the front center console 60 and the rear center console 70 is located frontward from the middle position of the intermediate floor 34 in the front-rear direction.

For example, the rear center console 70 may extend to divide the intermediate floor 34 at the middle position in the width direction of the vehicle.

The rear center console 70 may reach the rear seat 46 and extend further rearward from the front end of the rear seat 46. The rear center console 70 is located near the middle position in the width direction of the vehicle, or for example, at the middle position in the width direction of the vehicle.

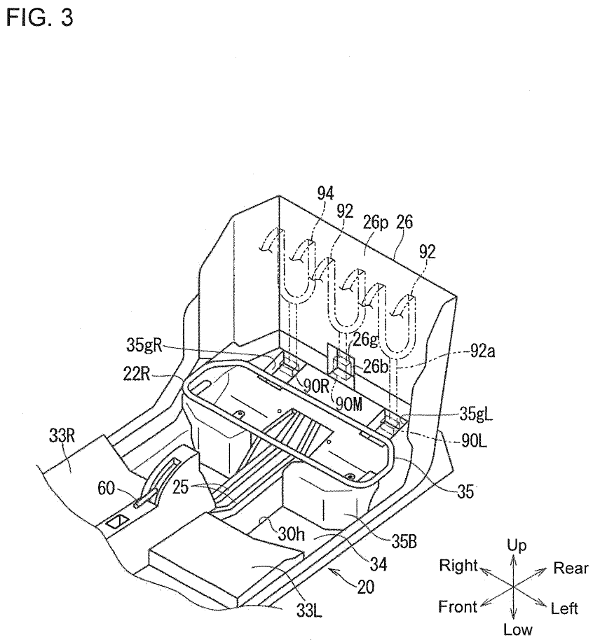

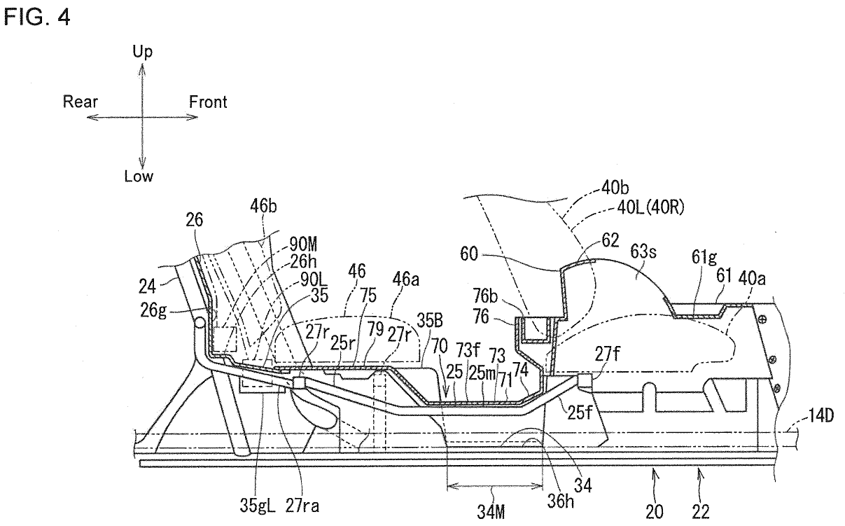

FIG. 3 is a perspective view of a rear portion of the vehicle 10. In FIG. 3, the rear seat 46 and the rear center console 70 are not shown. FIG. 4 is a partial cross-sectional view taken along line IV-IV in FIG. 1.

The rear seat 46 is supported on the floor 30 with the structure described below. As shown in FIGS. 1 to 4, the floor 30 includes the rear-seat base 35 located behind the intermediate floor 34. The rear-seat base 35 protrudes upward from the intermediate floor 34 behind the intermediate floor 34. The rear-seat base 35 may be covered with an under-seat cover 35B from the front. For example, left and right portions of the rear-seat base 35 may each be covered with the under-seat cover 35B.

The frame 22 includes a rear-seat support frame 27r located in the rear-seat base 35. A rectangular rear-seat mounting frame 22R is fixed to the rear-seat support frame 27r in the rear-seat base 35 with the top panel of the rear-seat base 35 between them. The rear seat 46 is fixed to the rear-seat mounting frame 22R. The rear seat 46 is thus supported by the vehicle body 20.

The intermediate floor 34 extends between the front seats 40R and 40L and the rear seat 46. The middle position of the intermediate floor 34 in the front-rear direction is, for example, the middle position between the boundary between the front-seat bases 33R and 33L and the intermediate floor 34 and the boundary between the rear-seat base 35 and the intermediate floor 34. The front end of the under-seat cover 35B may be located at the boundary between the rear-seat base 35 and the intermediate floor 34.

The rear edge of the rear-seat base 35 reaches the lower edge of a back member 26p. In the present embodiment, the rear end of the rear-seat base 35 is raised upward. The back member 26p is continuous with the upper edge of the raised rear end of the rear-seat base 35. In the present embodiment, the vehicle body 20 includes the back panel 26 located behind the rear seat 46. The back panel 26 includes the raised rear end of the rear-seat base 35 and the back member 26p.

The floor 30 has a console opening 30h in its portion receiving the rear center console 70. For example, the console opening 30h extends in the front-rear direction at the middle position of the intermediate floor 34 in the width direction of the vehicle. The console opening 30h may reach the rear-seat base 35. For example, the rear end of the console opening 30h may be located in the middle of the rear-seat base 35 in the front-rear direction. The console opening 30h may reach a position between the front-seat bases 33R and 33L. For example, the console opening 30h may extend between the front-seat base 33R and the front-seat base 33L and through the front floor 32 to reach the instrument panel 18.

The vehicle body 20 may include under-console frames 25 extending in the front-rear direction between the front seats 40R and 40L and the rear seat 46 in the front-rear direction. For example, the frame 22 includes a front-seat support frame 27f supporting the front seats 40R and 40L. The front-seat support frame 27f extends in the width direction of the vehicle in the front-seat bases 33R and 33L and in or under the front center console 60. The rear-seat support frame 27r extends in the width direction of the vehicle in the rear-seat base 35. The front ends of the under-console frames 25 are connected to the front-seat support frame 27f in or under the front center console 60. The rear ends of the under-console frames 25 are connected to the rear-seat support frame 27r in or under the rear center console 70. The front ends and the rear ends of the under-console frames 25 are located upward from the intermediate floor 34. The front ends and the rear ends of the under-console frames 25 are located downward from the top panels of the front-seat bases 33R and 33L and the top panel of the rear-seat base 35.

Each under-console frame 25 is recessed downward in an area including a middle position 34M of the intermediate floor 34 in the front-rear direction. For example, an intermediate portion 25m of each under-console frame 25 in the longitudinal direction extends in the front-rear direction along the intermediate floor 34. The intermediate portion 25m of each under-console frame 25 may extend in the horizontal direction perpendicular to the direction of gravity. A front portion 25f of each under-console frame 25 frontward from the intermediate portion 25m is inclined downward toward the rear. A rear portion 25r of each under-console frame 25 rearward from the intermediate portion 25m is inclined upward toward the rear. The middle position 34M of the intermediate floor 34 in the front-rear direction is along the intermediate portion 25m. In this manner, each under-console frame 25 is recessed downward in the area including the middle position 34M.

The intermediate portion 25m may be located higher than the intermediate floor 34. The under-console frames 25 may pass through the console opening 30h to be located higher than the intermediate floor 34. The frame 22 including, separately from portions extending under the floor 30, the under-console frames 25 extending in the front-rear direction upward from the intermediate floor 34 is more rigid.

The shape of the under-console frames 25 is not limited to the shape in the above example. For example, the under-console frames may extend straight. The under-console frames 25 may be eliminated.

The frame 22 includes two under-console frames 25. The frame 22 may include any number of under-console frames 25, and may include a single under-console frame 25.

A drive shaft 14D for transmitting the rotational driving force of the driving system 14 may be located downward from the under-console frames 25. The drive shaft 14D may be located in the middle of the width of the vehicle. The drive shaft 14D may be located downward from the intermediate floor 34.

The front center console 60 is, for example, a component integrally molded from resin. The front center console 60 may include left and right sidewalls 60w, a rear wall 60r, and an upper plate 60t and may be hollow with an opening at the bottom. The space in the front center console 60 is separated from the surrounding space by at least the left and right sidewalls 60w, the rear wall 60r, and the upper plate 60t. The front center console 60 may include a front wall to be partitioned from the instrument panel 18.

The front center console 60 may include a rear portion 62 protruding more upward than a front portion 61. The front portion 61 may include a tray-shaped storage recess 61g having an open top. The front portion 61 may be located frontward from, for example, the middle position of the seat bottom 40a in the front-rear direction.

The rear portion 62 is located in an area extending from the seat bottom 40a to the backrest 40b in the front-rear direction. The rear portion 62 protruding upward may curve arcuately from the rear end of the front portion 61. A brake lever 66 is joined to the rear portion 62. The brake lever 66 receives an operation for locking or unlocking the rotation of any wheel 12. The rear portion 62 is located higher than the seat bottom 40a. The brake lever 66 is thus also located higher than the seat bottom 40a.

The front center console 60 is fixed to the vehicle body 20 by, for example, screwing.

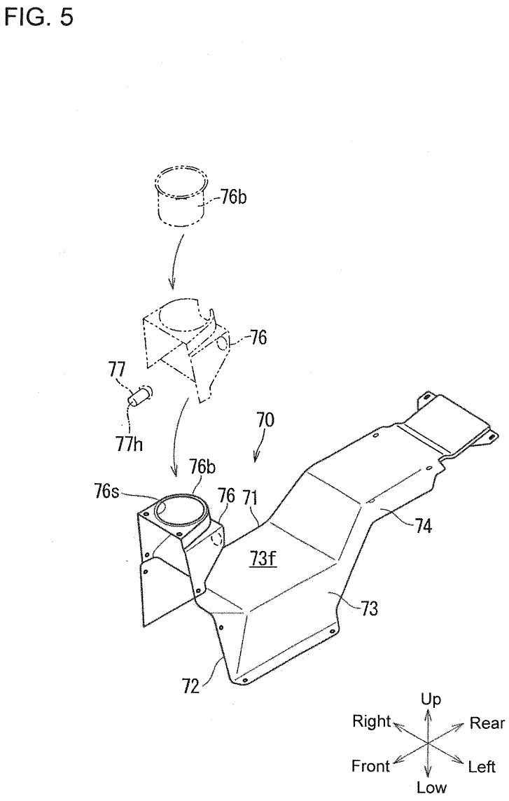

FIG. 5 is a perspective view of the rear center console 70.

The rear center console 70 is a resin component formed by molding. The rear center console 70 may be a single component or include multiple components.

The rear center console 70 extends further rearward from the rear end of the front center console 60.

The boundary between the front center console 60 and the rear center console 70 may at least partially overlap the backrests 40b of the front seats 40R and 40L as viewed in the width direction of the vehicle. In this case, the rear center console 70 can be easily extended in the front-rear direction on the intermediate floor 34. The front center console 60 reaching the backrests 40b can be easily replaced in correspondence with the shape of the rear seat. The front end of the rear center console 70 may be located frontward from the rear end of the seat bottom 40a.

The rear center console 70 may include a storage 76 defining a storage space 76s. The storage 76 may have any shape. For example, the storage 76 may be a cup holder. The storage may be tray-or box-shaped. The storage may include a lid. The rear center console 70 may eliminate the storage 76.

The rear center console 70 extends under the bench seat bottom 46a to avoid extending on the bench seat surface 46af. More specifically, the rear center console 70 does not divide the rear-seat base 35 laterally. The rear center console 70 may extend further rearward from the middle position of the bench seat bottom 46a in the front-rear direction.

The rear end of the rear center console 70 may be located frontward from the rear end of the bench seat bottom 46a. This allows the rear center console 70 to be easily mounted on the frame 22 and simplifies the structure of the peripheral portions of the back panel 26. The seatbelt retractor, such as a rear seat center-seatbelt retractor 90M, can thus be easily joined to the back panel 26. The rear end of the rear center console 70 may be located frontward from the back panel 26.

The rear center console 70 closes the console opening 30h on an imaginary rearward extension from the front center console 60. As described above, the under-console frames 25 are located upward from the console opening 30h. Thus, the rear center console 70 closing the console opening 30h covers the area above and lateral to the under-console frames 25.

For example, the rear center console 70 includes a console body 71. The console body 71 includes a front portion 72, an intermediate portion 73, and a rear portion 74. The front portion 72, the intermediate portion 73, and the rear portion 74 are continuous with one another in this order from the front to the rear.

The intermediate portion 73 includes left and right sidewalls and an upper plate connecting the upper edges of the left and right sidewalls. The intermediate portion 73 is open at the bottom.

The front portion 72 is continuous with the front end of the intermediate portion 73. The front portion 72 includes left and right sidewalls and an upper plate connecting the upper edges of the left and right sidewalls. The upper plate of the front portion 72 is inclined upward toward the front from the upper plate of the intermediate portion 73. The space in the intermediate portion 73 is continuous with the space in the front portion.

The rear portion 74 is continuous with the rear end of the intermediate portion 73. The rear portion 74 includes left and right sidewalls and an upper plate connecting the upper edges of the left and right sidewalls. The upper plate of the rear portion 74 includes a portion inclined upward toward the rear from the upper plate of the intermediate portion 73 and a portion extending rearward horizontally from the rear end of the inclined portion.

The rear center console 70 is fixed to the floor 30 to cover the console opening 30h. For example, the rear center console 70 is fixed to the floor 30 with, for example, screws at its lower ends of the left and right sidewalls, at its two side portions of the upper plate, and at its rear end. The front end of the rear center console 70 is fixed to the front center console 60 with, for example, screws.

With the under-console frames 25 located upward from the intermediate portion 73, the rear center console 70 bridges over the under-console frames 25 in the width direction of the vehicle to cover the under-console frames 25. The intermediate portion 73 closes the console opening 30h on the intermediate floor 34. The height of the upper plate of the intermediate portion 73 from the intermediate floor 34 may be the vertical length of the left and right sidewalls of the intermediate portion 73.

The rear portion 74 closes the console opening 30h in the rear-seat base 35. The rear portion 74 closes the console opening 30h under the bench seat bottom 46a in the rear seat 46. The vertical length of the left and right sidewalls of the rear portion 74 may be smaller than the vertical length of the left and right sidewalls of the intermediate portion 73. The rear end of the rear portion 74 may have no left and right sidewalls. For example, the rear portion 74 closing the console opening 30h may not protrude from the rear-seat base 35 in the portion of the rear-seat base 35 protruding most upward near the rear end of the rear-seat base 35. The rear portion 74 closing the console opening 30h may protrude upward from the rear-seat base 35 near the front end of the rear-seat base 35. This allows the under-console frames 25 to be easily at a highest possible position.

As described in a second embodiment, the portion of the console opening 30h located in the rear-seat base 35 can be a portion receiving a rear center console 170 with another shape. The rear center console 70 closing the console opening 30h under the rear seat 46 can close the opening in which the rear center console 170 with another shape is placed. In other words, the console opening 30h located in the rear-seat base 35 allows the rear center console 170 with another shape to be at a most rearward possible position relative to the rear-seat base 35. This allows the rear center console 170 to provide a larger storage space or have a shape suitable for elbow rest.

The upper plate of the rear center console 70 is lowest in the intermediate portion 73. The upper plates of the front portion 72 and the rear portion 74 are located higher than the upper plate of the intermediate portion 73. Thus, the upper plate of the rear center console 70 is recessed in the intermediate portion 73 to cause the upper plate of the intermediate portion 73 to be at the lowest position.

The up-facing surface of the upper plate of the intermediate portion 73 is an example of a rear console surface 73f. The rear console surface 73f extends in the front-rear direction between the front seats 40R and 40L and the rear seat 46 in the front-rear direction. The rear console surface 73f is parallel to the intermediate floor 34. The rear console surface 73f may be perpendicular to the direction of gravity.

With the under-console frames 25 located higher than the intermediate floor 34, the rear console surface 73f is located higher than the intermediate floor 34. The rear console surface 73f is located lower than the bench seat surface 46af. The users of the rear seat 46 seated on the rear seat 46 can thus place their feet on the rear console surface 73f. The users of the rear seat 46 can easily cross over to the left and right of the rear center console 70.

The storage 76 may be separate from the console body 71. For example, the storage 76 is attached to the upper end of the front portion 72 and protrudes upward from the front portion 72. The storage 76 may protrude rearward from the upper portion of the front portion 72. The storage 76 is fixed to, for example, the console body 71 or the front center console 60, or both to remain continuous with the console body 71. The storage 76 may be fixed by, for example, screwing.

For example, the storage 76 flares more in the upper portion than in the lower portion as viewed laterally. The front end of the storage 76 extends straight as viewed laterally. The upper portion of the storage 76 thus protrudes more rearward than the lower portion to flare more than the lower portion.

The storage 76 is open at the front. The front ends of the console body 71 and the storage 76 are continuous with the rear end of the front center console 60. In this state, the front opening of the storage 76 is closed by the rear wall 60r of the front center console 60.

The portion of the upper plate of the console body 71 continuous with the storage 76 may be open, and the storage 76 may open at the bottom. In this case, the space in the console body 71 and the space in the storage 76 can be continuous without being divided.

In the present embodiment, the storage 76 includes a cup holder 76b. The cup holder 76b defines the storage space 76s. For example, the cup holder 76b is a bottomed cylindrical container that is open at the top. The cup holder 76b is supported by the body of the storage 76 to open at the top in the storage 76. The inner circumferential surface of the cup holder 76b defines the storage space 76s.

The storage 76 protrudes rearward, and thus the storage space 76s can be enlarged easily. The console body 71 and the storage 76 as separate members can be shaped to protrude rearward more easily than when the two components are molded integrally from, for example, resin.

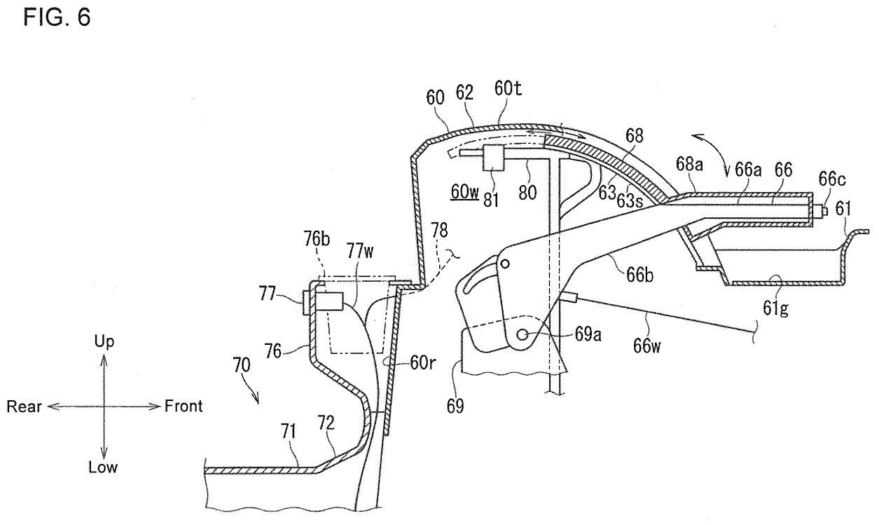

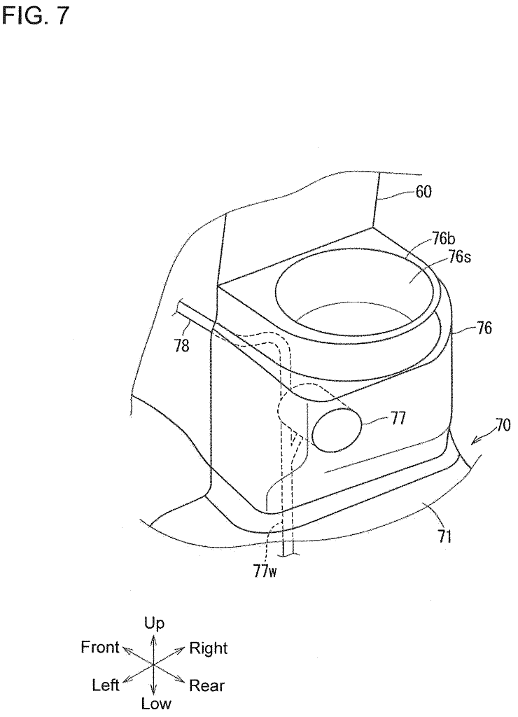

FIG. 6 is a cross-sectional view of a connecting portion of the front center console 60 and the rear center console 70. FIG. 7 is a rear perspective view of the storage 76 in the rear center console 70.

As shown in FIGS. 5 to 7, an electrical component 77 may be mounted on the rear center console 70. The electrical component 77 conducts electricity. The electrical component 77 may be an electrical accessory component that provides convenience to the occupant. The electrical component 77 may be an accessory socket for supplying electric power.

The electrical component 77 may be incorporated in the storage 76. The electrical component 77 incorporated in the storage 76 is located higher than the console body 71. The occupant of the rear seat 46 can thus easily access the electrical component 77. The electrical component 77 may be incorporated in the console body 71.

For example, the electrical component 77 may be incorporated in a portion of the storage 76 protruding rearward. The electrical component 77 may be incorporated to face rearward relative to the storage 76. The electrical component 77 may be positioned offset to the right or left to avoid interference with the cup holder 76b.

A wire 77w from the electrical component 77 may extend toward the floor 30. The wire 77w may extend under the floor 30 to be connected to another electrical component, such as a power supply device.

The wire 77w extends from the electrical component 77 in the storage 76. As described above, the space in the console body 71 and the space in the storage 76 are continuous without being divided. The wire 77w can thus extend from the space in the storage 76 and through the space in the console body 71, and then drawn to a position under the floor 30 through the bottom opening of the console body 71.

The front center console 60 may receive a tube 80 through which fuel components pass. The tube 80 allows passage of, for example, a fuel mixture containing fuel components. The tube 80 may be, for example, an evaporative tube through which a fuel mixture evaporating from, for example, a fuel tank passes. The tube 80 received in the front center console 60 may extend from under the floor 30 through the bottom opening of the front center console 60. The tube 80 is fixed in the front center console 60 with, for example, a tube fastener 81.

As described above, the space in the front center console 60 is divided from the space in the rear center console 70. In the present embodiment, the rear wall 60r of the front center console 60 separates the two spaces. This separates the space in which the tube 80 is located to allow passage of fuel components and the section in which the electrical component 77 is located. The two spaces may be separated by a partition supported by the rear center console, or by a component other than the front center console or the rear center console.

The vehicle 10 may include a front-seat wire 78. The front-seat wire 78 is, for example, connected to a seatbelt wearing detection sensor for the front-seat seatbelt 42. In this case, the front-seat wire 78 is routed to the buckle 42b for the front-seat seatbelt 42. The front-seat wire 78 may be connected to a seating sensor that detects any person seated on the front seat 40R or 40L, or to a seat heater that warms the front seat 40R or 40L.

The front-seat wire 78 may be routed in the manner described below. For example, the front-seat wire 78 extends under the floor 30 and is guided into the rear center console 70 through the bottom opening of the rear center console 70. The front-seat wire 78 may be partially bundled with the wire 77w to be guided into the rear center console 70. In this case, the front-seat wire 78 is guided into the front portion 72 of the console body 71 and the storage 76 together with the wire 77w. The front-seat wire 78 branches from the wire 77w in the storage 76 and is drawn out of the rear center console 70.

The front-seat wire 78 may extend out of the rear center console 70 through the boundary between the rear center console 70 and the front center console 60 and extend toward the front seat 40R or the front seat 40L. For example, the rear center console 70 has an open front end. More specifically, the storage 76 has an open front end. Thus, a gap for allowing the front-seat wire 78 to pass through is easily left between the front opening edge of the storage 76 and the rear end of the front center console 60. The front-seat wire 78 extends out of the rear center console 70 through the gap. The front-seat wire 78 is then connected to, for example, the seatbelt wearing detection sensor in the buckle 42b for the front seat 40R.

Thus, the front-seat wire 78 can be easily drawn out of the rear center console 70 toward the front seat 40R or the front seat 40L without any hole or recess formed in the rear center console 70 for receiving the front-seat wire.

The space in the front center console 60 and the section in the rear center console 70 are separated from each other by the rear wall 60r of the front center console 60, and the rear center console 70 is open at the front. Thus, the front-seat wire 78 can be easily drawn out of the rear center console 70 from inside the rear center console 70, with the two spaces separated from each other.

The brake lever 66 will now be described with reference to FIGS. 1 to 3 and 6. The brake lever 66 is elongated. For example, the brake lever 66 includes an operable portion 66a and a base 66b extending further from the operable portion 66a. The operable portion 66a is thin enough to be gripped by hand. The base 66b may be wider than the operable portion 66a.

A brake support bracket 69 supported by, for example, the frame 22 is located in the front center console 60. The brake support bracket 69 supports a support shaft 69a in the front center console 60. The base 66b of the brake lever 66 is pivotally supported by the brake support bracket 69 with the support shaft 69a.

The front center console 60 has a brake slot 63s with the height changing along its length. For example, the front center console 60 includes a covering portion 63 located away from the support shaft 69a. In the present embodiment, the covering portion 63 is an arcuate plate portion of the rear portion 62 located obliquely frontward away from the support shaft 69a. The covering portion 63 may be an elongated arcuate plate surrounding the support shaft 69a. The covering portion 63 may be an elongated plate arcuate about the central axis of the support shaft 69a. The covering portion may not be an arcuate plate. For example, the covering portion may be an elongated plate inclined upward toward the rear.

The covering portion 63 has the brake slot 63s extending in the direction in which the covering portion 63 extends. The brake slot 63s extends along the shape of the covering portion 63, and thus has the height changing along its length based on the shape of the covering portion 63. For example, the brake slot 63s has the height changing in the extending direction of the covering portion 63 by curving arcuately in the thickness direction of the covering portion 63 based on the shape of the covering portion 63. The brake slot 63s is at a height increasing rearward.

The covering portion 63 has the brake slot 63s in its front portion. The covering portion 63 curves arcuately from the rear end of the brake slot 63s and extends rearward further.

The brake lever 66 is supported pivotally while protruding out of the front center console 60 through the brake slot 63s. For example, the base 66b is located in the front center console 60. The operable portion 66a is located outside the front center console 60. The boundary between the base 66b and the operable portion 66a is located in the brake slot 63s. The operable portion 66a is operated vertically to cause the brake lever 66 to move pivotally.

The brake lever 66 may be locked to pivot in a predetermined direction by, for example, a latch assembly. The latch assembly may be unlocked in response to an operation on an unlock button 66c.

A brake wire 66w is connected to the brake lever 66 in the front center console 60. The brake wire 66w is connected to the brake system of the wheels 12. In response to the brake lever 66 moved pivotally, the brake system switches between applying the brakes to the wheels 12 and releasing the brakes on the wheels 12. An operation on the brake lever 66 may control the operation of an electric brake.

A cover 68 may extend upward from the brake lever 66 along the brake slot 63s. The brake slot 63s is thus closed at a higher position than the position of the brake lever 66.

For example, the cover 68 may be integral with an operable portion cover 68a covering the operable portion 66a. The operable portion cover 68a is cylindrical and can be externally fitted to the operable portion 66a. The cover 68 extends from the basal end of the operable portion cover 68a.

The cover 68 extends along the brake slot 63s. For example, the cover 68 is an elongated plate curved arcuately in the thickness direction.

The cover 68 may be located in the brake slot 63s or outside or inside the covering portion 63. For example, the cover 68 may be located outside the covering portion 63 with part of the cover 68 located in the brake slot 63s.

When the operable portion 66a of the brake lever 66 is near the lower end of the brake slot 63s, the wheels 12 are not braked. In this state, the vehicle 10 travels.

When the operable portion 66a of the brake lever 66 is located at the lower end of the brake slot 63s, the brake slot 63s is open upward from the operable portion 66a. The cover 68 extends upward from the brake lever 66 along the brake slot 63s to cover the brake slot 63s. Thus, the cover 68 is likely to close a large part of the brake slot 63s during the travel of the vehicle 10.

The cover 68 does not extend downward from the operable portion 66a, and is thus less likely to interfere with components of the front center console 60, such as the brake wire 66w.

When the operable portion 66a of the brake lever 66 is located near the upper end of the brake slot 63s, the wheels 12 are braked. In this state, the vehicle 10 stops.

When the operable portion 66a of the brake lever 66 is located at the upper end of the brake slot 63s, the brake slot 63s is open downward from the operable portion 66a. The cover 68 extends rearward from the brake lever 66 and extends along an imaginary rearward extension from the brake slot 63s in the covering portion 63. For example, the cover 68 is located within an imaginary rearward extension from the brake slot 63s in the covering portion 63.

Although the brake slot 63s is open downward from the operable portion 66a, the opening is located downward from the operable portion 66a and faces frontward rather than upward. Thus, dust is less likely to enter the front center console 60 through the opening than when the brake slot 63s is open upward from the operable portion 66a. Further, the stopped vehicle 10 is less likely to have dust suspended in the air. Dust is thus less likely to enter the front center console 60.

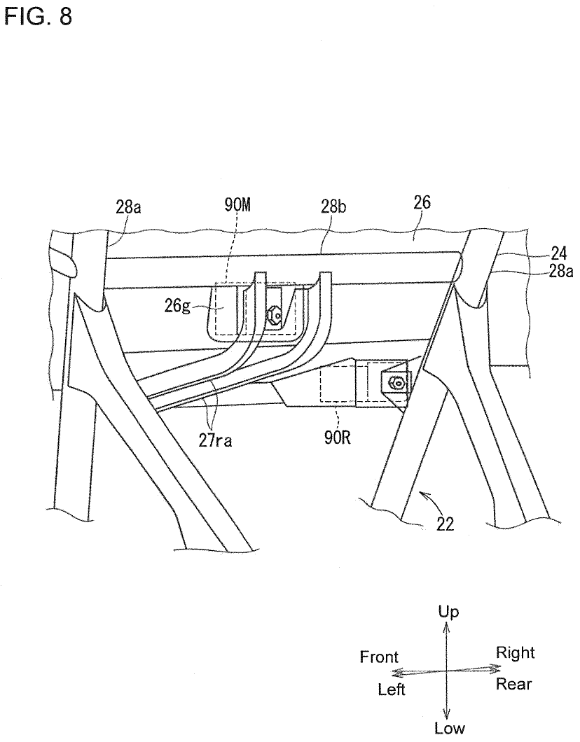

Seatbelt retractors 90R, 90L, and 90M for the rear seat will now be described. FIG. 8 is a rear perspective view of the rear-seat base 35 and the back panel 26.

As shown in FIGS. 3, 4, and 8, the vehicle 10 includes the rear seat center-seatbelt retractor 90M. The rear seat center-seatbelt retractor 90M stores a shoulder belt 92a of a seatbelt 92 in a manner extendable and retractable. The shoulder belt 92a extends from the rear seat center-seatbelt retractor 90M, branches in two, and extends frontward out of the backrest 40b. The two ends of the shoulder belt 92a are detachably connected to the waist belt located in a rear portion of the bench seat bottom 46a with, for example, a buckle. The occupant seated in the middle of the rear seat 46 can wear a four-point seatbelt.

The rear seat center-seatbelt retractor 90M is located on an imaginary rearward extension from the rear center console 70. For example, the back panel 26 has, at the bottom of its middle portion in the width direction of the vehicle, a recessed portion 26g recessed rearward. The recessed portion 26g receives the rear seat center-seatbelt retractor 90M.

When the rear seat is for two occupants as in the second embodiment, the rear seat center-seatbelt retractor 90M may be eliminated. In this case, the back panel 26 has an opening 26h remaining open frontward. The recessed portion 26g located on an imaginary rearward extension from the rear center console can be easily closed at the opening 26h by replacing the rear center console.

The recessed portion 26g is located behind the rear seat 46. The rear seat center-seatbelt retractor 90M located in the recessed portion 26g is also located behind the rear seat 46.

The rear frame 24 may include back vertical frames 28a and a back transverse frame 28b. For example, the back vertical frames 28a stand behind the respective left and right portions of the back panel 26. The back vertical frames 28a stand upward from, for example, a portion of the frame 22 extending under the floor 30. The back transverse frame 28b extends across the back vertical frames 28a. The back transverse frame 28b has its two ends joined to the left and right back-vertical frames 28a by, for example, welding. The back panel 26 is supported by the back vertical frames 28a and the back transverse frame 28b from the rear.

The under-console frames 25 have their rear ends connected to the rear-seat support frame 27r. Left and right under-rear seat frames 27ru are located between the rear-seat support frame 27r and the back transverse frame 28b. The left and right under-rear seat frames 27ru are spaced from each other in the width direction of the vehicle. The spacing between the left and right under-rear seat frames 27ru is too small to receive, for example, the rear seat center-seatbelt retractor 90M. For example, the left and right under-rear seat frames 27ru are located respectively on imaginary rearward extensions from the left and right under-console frames 25.

The front ends of the left and right under-rear seat frames 27ru are joined to the rear-seat support frame 27r by, for example, welding. The rear ends of the left and right under-rear seat frames 27ru are curved upward at a position rearward from the rear-seat base 35 and joined to the back transverse frame 28b by, for example, welding.

The under-rear seat frames 27ru each include a portion extending rearward from below the rear seat 46 at the middle position in the rear seat 46 in the width direction of the vehicle. The vertical spacing between the rear-seat base 35 and the left and right under-rear seat frames 27ru is too small to receive the rear seat center-seatbelt retractor 90M. The left and right under-rear seat frames 27ru are thus at, for example, highest possible positions, increasing the rigidity of the entire frame 22 easily. In contrast, the spacing in the front-rear direction between the rear ends of the left and right under-rear seat frames 27ru and the back panel 26 is larger than the vertical spacing described above. The recessed portion 26g is thus located in a middle portion of the lower portion of the back panel 26 in the width direction of the vehicle. The recessed portion 26g protruding rearward from the back panel 26 is located frontward from the rear ends of the left and right under-rear seat frames 27ru and the back transverse frame 28b. The rear seat center-seatbelt retractor 90M located in the recessed portion 26g is fixed to the back transverse frame 28b through a hole in the bottom of the recessed portion 26g. For example, the rear seat center-seatbelt retractor 90M is fixed to, with screws or other fasteners, a bracket, which is joined to the back transverse frame 28b by, for example, welding.

In this manner, the rear seat center-seatbelt retractor 90M is located behind the rear seat 46, rather than under the rear seat 46. This allows setting the height positions of the rear-seat base 35 and the rear seat 46 with less likelihood of being affected by the height positions of the left and right under-rear seat frames 27ru. This increases the layout flexibility for the height position of the rear seat 46.

Each of the rear seat right-seatbelt retractor 90R and the rear seat left-seatbelt retractor 90L stores the shoulder belt 92a of the rear-seat seatbelt 92 in an extendable and retractable manner, similarly to the rear seat center-seatbelt retractor 90M. The rear seat right-seatbelt retractor 90R is for the occupant seated on the right of the rear seat 46. The rear seat left-seatbelt retractor 90L is for the occupant seated on the left of the rear seat 46.

The rear seat right-seatbelt retractor 90R is located on the right of the under-rear seat frame 27ru. The rear seat left-seatbelt retractor 90L is located on the left of the under-rear seat frame 27ru.

The rear-seat base 35 includes a right recessed portion 35gR and a left recessed portion 35gL, for example. The right recessed portion 35gR is located near the rear end of the rear-seat base 35 and in front of the right back-vertical frame 28a. The right recessed portion 35gR receives the rear seat right-seatbelt retractor 90R. The right recessed portion 35gR protrudes downward from the rear-seat base 35. The rear seat right-seatbelt retractor 90R received in the right recessed portion 35gR is fixed to the right back-vertical frame 28a through a hole in the rear sidewall of the right recessed portion 35gR. For example, a bracket is fixed to protrude frontward from a middle portion of the back vertical frame 28a in the longitudinal direction. The rear seat right-seatbelt retractor 90R is fixed to the right back-vertical frame 28a with the bracket.

The left recessed portion 35gL is located near the rear end of the rear-seat base 35 and in front of the left back-vertical frame 28a. Similarly to the rear seat right-seatbelt retractor 90R, the rear seat left-seatbelt retractor 90L is received in the left recessed portion 35gL and fixed to the left back-vertical frame 28a.

As viewed in the width direction of the vehicle, at least part of the rear seat right-seatbelt retractor 90R and at least part of the rear seat left-seatbelt retractor 90L overlap the under-rear seat frames 27ru. For example, the right recessed portion 35gR and the left recessed portion 35gL protrude downward from the right and left under-rear seat frames 27ru at positions laterally outward from the left and right under-rear seat frames 27ru. The rear seat right-seatbelt retractor 90R and the rear seat left-seatbelt retractor 90L received in the right recessed portion 35gR and the left recessed portion 35gL also overlap the right and left under-rear seat frames 27ru as viewed in the width direction of the vehicle.

More specifically, the rear seat right-seatbelt retractor 90R and the rear seat left-seatbelt retractor 90L may be located at about the same height position as or at a lower height position than the right and left under-rear seat frames 27ru, while avoiding interference with the right and left under-rear seat frames 27ru outwardly in the width direction of the vehicle. This allows the rear-seat base 35 and the rear seat 46 to be easily positioned at any height, increasing the height flexibility of the rear seat 46.

The rear seat right-seatbelt retractor 90R and the rear seat left-seatbelt retractor 90L are located in a lower portion of the rear seat 46. Thus, the shoulder belt 92a extended from the rear seat right-seatbelt retractor 90R or the rear seat left-seatbelt retractor 90L can extend upward from near the lower end of the back panel 26, and can be longer. This allows the shoulder belt 92a extendable from and retractable into the rear seat right-seatbelt retractor 90R or the rear seat left-seatbelt retractor 90L to easily have an intended length, thus allowing easy length adjustment of the shoulder belt 92a.

In the vehicle 10 with the above structure, the rear center console 70 extends rearward from a position frontward from the middle position of the intermediate floor 34 in the front-rear direction. The front center console 60 and the rear center console 70 can thus be replaced separately. For example, the rear center console 70 may be replaced with a rear center console with another shape without replacing the front center console 60. The structure allows easy replacement of the rear center console. For example, the rear center console that is less tall may be used to allow the occupant to easily cross over the rear center console. The rear center console that is taller may be used to allow the occupant to easily place objects.

The boundary between the front center console 60 and the rear center console 70 may at least partially overlap the backrest 40b as viewed in the width direction of the vehicle. In this case, the rear center console 70 can be easily extended in the front-rear direction on the intermediate floor 34. Such a rear center console can be easily replaced.

The rear center console 70 includes the storage 76 defining the storage space 76s. The rear center console 70 can thus provide the storage space 76s easily accessible to the user of the rear seat 46.

When the rear seat includes the bench seat bottom 46a, the rear center console 70 may extend under the bench seat bottom 46a to avoid extending on the bench seat surface 46af. This allows effective use of the bench seat surface 46af of the bench seat bottom 46a. For example, a width for three occupants can be easily achieved.

The rear end of the rear center console 70 may be located frontward from the rear end of the bench seat bottom 46a. In this case, the rear center console 70 can be easily mounted on the vehicle 10.

When the rear seat center-seatbelt retractor 90M is located on an imaginary rearward extension from the rear center console 70, the rear center console may be replaced to easily allow installation or non-installation of the rear seat center-seatbelt retractor.

When the rear console surface 73f is located lower than the bench seat surface 46af, the users of the rear seat 46 can easily place their feet on the rear center console 70 or cross over to the left or right of the rear center console 70.

The rear center console 70 including the storage 76 protruding upward and rearward from the front portion of the console body 71 can easily provide a larger storage space 76s at a position higher than the console body 71.

The space in the front center console 60 is separated from the space in the rear center console 70. The tube 80 for passage of fuel components is located in the front center console 60, and the electrical component 77 is mounted on the rear center console 70. The space in which the tube 80 for passage of fuel components extends is separate from the section in which the electrical component 77 is located.

The under-console frames 25 increase the rigidity of the frame 22. The under-console frames 25 recessed downward in the area including the middle position 34M of the intermediate floor 34 in the front-rear direction can easily lower the rear center console and increase the storage space in the rear center console.

The front-seat wire 78 is guided from under the rear center console 70 into the rear center console 70, and extends out of the rear center console 70 toward the front seats 40R and 40L through the boundary between the rear center console 70 and the front center console 60. In this case, the front-seat wire 78 is easily routed from the rear center console 70 to the front seat.

The front center console 60 has the brake slot 63s with the height changing along its length. The cover 68 extends upward from the brake lever 66 along the brake slot 63s. This structure reduces entry of foreign matter into the front center console 60 through the brake slot 63s.

At least part of the rear seat right-seatbelt retractor 90R and at least part of the rear seat left-seatbelt retractor 90L overlap the under-rear seat frames 27ru as viewed in the width direction of the vehicle. This increases the flexibility in the height position of the rear seat 46. For example, the rear seat 46 is installed at a lowest possible position. Each of the rear seat right-seatbelt retractor 90R and the rear seat left-seatbelt retractor 90L is located on the right or left of the under-rear seat frame 27ru under the rear seat 46. This easily allows the shoulder belt 92a to be extended out of the seatbelt retractor 90R or 90L by an intended length.

The rear seat center-seatbelt retractor 90M is located behind the rear seat 46, thus increasing the flexibility in the height position of the rear seat 46.

### Second Embodiment

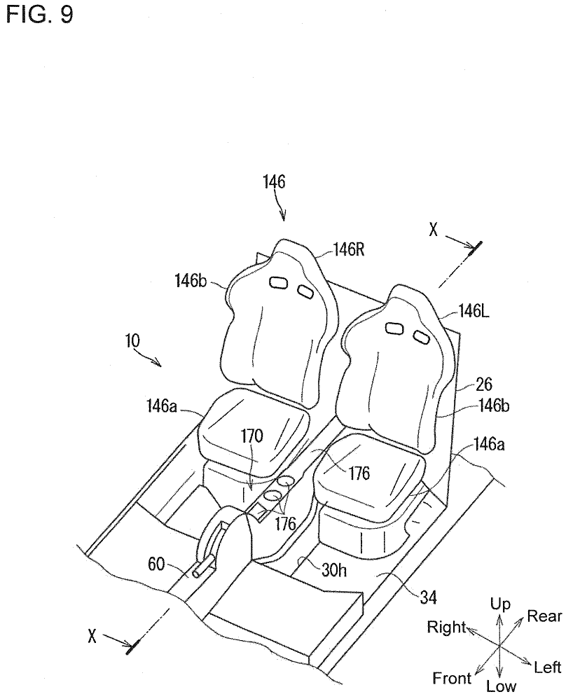

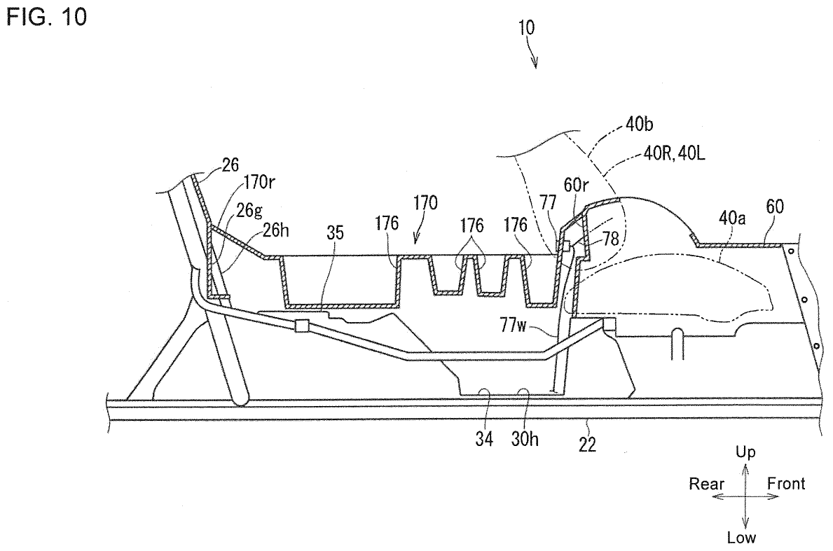

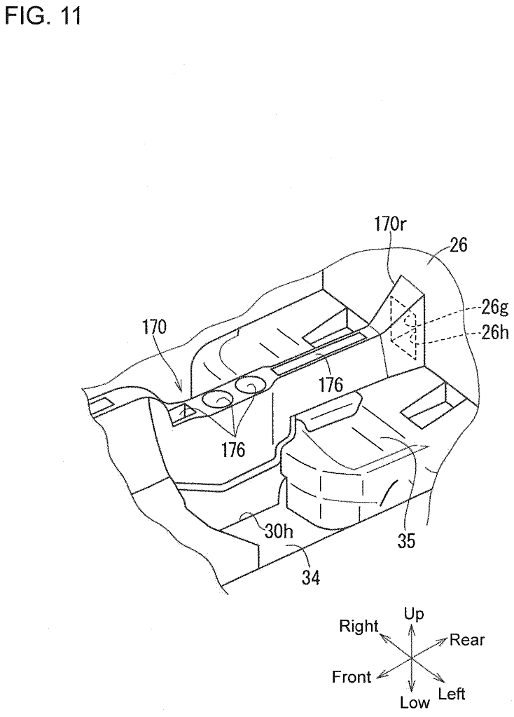

A vehicle 110 according to the second embodiment will now be described. FIG. 9 is a partial perspective view of the vehicle 110. FIG. 10 is a cross-sectional view taken along line X-X in FIG. 9. FIG. 11 is a partial perspective view of the vehicle 110. In FIGS. 9 and 11, the front seats 40R and 40L are not shown. In FIG. 10, the front seats 40R and 40L are indicated by two-dot-dash lines. In FIGS. 10 and 11, rear seats 146 are not shown. In the present embodiment, the same reference numerals denote the same components described in the first embodiment. Such components will not be described.

The vehicle 110 differs from the vehicle 10 in the structure described below.

The vehicle 110 includes the rear seats 146 including a right rear seat 146R and a left rear seat 146L, in place of the rear seat 46 including the bench seat bottom 46a. The right rear seat 146R and the left rear seat 146L are separate from each other laterally. The rear seats 146 may be referred to as separate rear seats 146.

The right rear seat 146R includes a seat bottom 146a and a backrest 146b. The seat bottom 146a is a portion on which an occupant sits. The backrest 146b protrudes upward from the seat bottom 146a behind the seat bottom 146a. The backrest 146b supports the back of the occupant seated on the seat bottom 146a from the rear.

The seat bottom 146a is wide enough to support a single occupant. For example, the seat bottom 146a has a width that is 50 percent or less of the total width of the vehicle 110, such as 1 m or less. The backrest 146b may be as wide as the seat bottom 146a.

The left rear seat 146L includes a seat bottom 146a and a backrest 146b, similarly to the right rear seat 146R.

The right rear seat 146R and the left rear seat 146L on the rear-seat base 35 are fixed to the frame 22 with a rear-seat mounting frame between the seats 146R and 146L and the frame 22. Unlike the rear-seat mounting frame 22R, the rear-seat mounting frame may be laterally separable. The right rear seat 146R and the left rear seat 146L are spaced from each other in the width direction of the vehicle.

In the vehicle 110, two occupants can be seated on the rear seats 146.

FIG. 11 is a perspective view of a rear center console 170.

As shown in FIGS. 9 to 11, the vehicle 110 includes the rear center console 170 in place of the rear center console 70. The rear center console 170 extends in the front-rear direction between the right rear seat 146R and the left rear seat 146L. The rear center console 170 is longer than the rear center console 70, and extends rearward beyond the intermediate floor 34 and across the rear seats 146.

For example, the rear center console 170 is separate from the front center console 60. The rear center console 170 extends further rearward from the rear end of the front center console 60. The rear center console 170 protrudes upward from the intermediate floor 34. The rear center console 170 extends rearward from a position frontward from the middle position of the intermediate floor 34 in the front-rear direction. More specifically, the boundary between the front center console 60 and the rear center console 170 is located frontward from the middle position of the intermediate floor 34 in the front-rear direction.

For example, the rear center console 170 may extend to separate the intermediate floor 34 at the middle position in the width direction of the vehicle.

The rear center console 170 reaches the rear seats 146 and extends further rearward from the front ends of the rear seats 146. The rear center console 170 is located near the middle position in the width direction of the vehicle, or for example, at the middle position in the width direction of the vehicle.

The rear center console 170 is a resin component formed by molding. The rear center console 170 may be a single component or include multiple components. In the present embodiment, the rear center console 170 is a single component.

Similarly to the rear center console 70, the boundary between the front center console 60 and the rear center console 170 may at least partially overlap the backrests 40b of the front seats 40R and 40L.

The rear center console 170 may include a storage 176 to define a storage space 176s. The storage 176 may have any shape. For example, the storage 176 may be a cup holder. The storage 176 may be tray-shaped or box-shaped. The storage may include a lid. The rear center console 170 may include no storage.

In the present embodiment, the rear center console 170 includes multiple storages 176 arranged in the front-rear direction. For example, the frontmost storage 176 is a rectangular recess. The second and third storages 176 from the front are circular recesses. Such storages 176 may be used as cup holders. The rearmost storage 176 is a rectangular recess.

The rear portion of the rear center console 170 extends rearward on the rear-seat base 35 between the right rear seat 146R and the left rear seat 146L. In other words, the rear center console 170 laterally separates the right rear seat 146R and the left rear seat 146L from each other.

The portion of the rear center console 170 overlapping the rear seats 146 in the front-rear direction is at a higher position than the seat bottoms 146a. The rearmost storage 176 is located in the portion of the rear center console 170 overlapping the rear seats 146 in the front-rear direction. In other words, the rear center console 170 includes one or more storages 176 at a position overlapping the rear seats 146 in the front-rear direction. The occupants seated on the rear seats 146 can easily use the storage 176 directly next to them.

The rear center console 170 extends toward the rear of the rear-seat base 35 to reach the back panel 26 while closing the console opening 30h. The lower edge of the rear center console 170 is, for example, screwed to the intermediate floor 34 and the rear-seat base 35 at the periphery of the console opening 30h. This fixes the rear center console 170 to the frame 22.

A rear end 170r of the rear center console 170 is shaped to close the opening 26h of the recessed portion 26g. For example, the rear end 170r is wider toward the rear to close the opening 26h.

For the separate rear seats 146, the rear seat center-seatbelt retractor 90M may be eliminated. The rear end of the rear center console 170 thus closes the opening 26h of the recessed portion 26g. This conceals the internal space of the recessed portion 26g from an external view.

The portion of the rear center console 170 located in the intermediate floor 34 in the front-rear direction may also be higher than the seat bottom 146a. This allows the storage 176 located near the intermediate floor 34 in the front-rear direction to be easily located at a higher position. The occupants of the rear seats 146 can easily access the storage 176 located more frontward than the rear seats 146. This structure also allows the storage space of the storage 176 to be designed larger.

The space in the rear center console 170 is defined between the left and right sidewalls. The rear center console 170 may have an open front end and an upper rear end.

The front end of the rear center console 170 may protrude upward. The electrical component 77 may be mounted on the protruding portion.

Similarly to the rear center console 70, the rear center console 170 may have an open front end. As in the first embodiment, the space in the front center console 60 and the space in the rear center console 170 may be separated by, for example, the rear wall 60r of the front center console 60. As in the first embodiment, the front-seat wire 78 may extend out of the rear center console 170 through the boundary between the front center console 60 and the rear center console 170.

The vehicle 110 produces the same advantageous effects as the vehicle according to the first embodiment, excluding the advantageous effects produced by the change of the rear seat from the bench seat to the separate seats.

With the rear seat changed from the bench seat to the separate seats, the rear center console 170 extends in the front-rear direction between the right rear seat 146R and the left rear seat 146L. The rear center console 170 thus separates the right rear seat 146R and the left rear seat 146L from each other. The rear center console 170 may provide the occupants of the rear seats 146 with highly usable equipment, such as the storages 176.

The rear center console 170 closes the opening 26h of the recessed portion 26g in the back panel 26. Thus, the rear center console 170 may be replaced to easily allow installation or non-installation of the rear seat center-seatbelt retractor 90M, which uses the opening 26h in the back panel 26.

### Third Embodiment

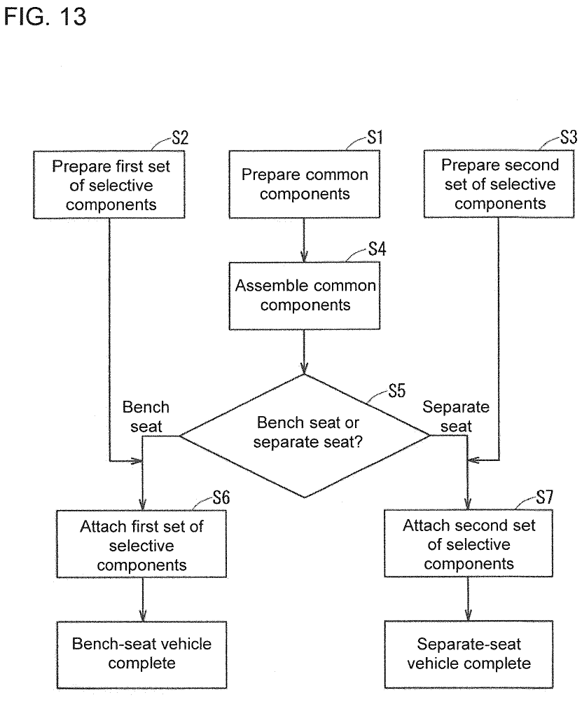

In a third embodiment, a method for manufacturing the vehicles 10 and 110 will be described. FIG. 13 is a flowchart showing the method for manufacturing the vehicles 10 and 110.

In step S1, the vehicle body 20 including the intermediate floor 34, the front seats 40R and 40L, and the front center console 60 are prepared as common components.

In step S2, the bench rear seat 46 including the bench seat surface 46af and the first rear center console 70 are prepared as a first set.

In step S3, the separate rear seats 146 including the right rear seat 146R and the left rear seat 146L and the second rear center console 170 are prepared as a second set.

The first set and the second set are selective component sets to be used selectively.

In step S4, the common components are assembled together. For example, the front seats 40R and 40L and the front center console 60 are mounted on the vehicle body 20.

Steps S1, S2, S3, and S4 may be performed in any order.

When the rear seat of the vehicle to be manufactured is a bench seat in step S5, the processing advances to step S6. When the rear seat of the vehicle to be manufactured is a separate seat, the processing advances to step S7.

In step S6, the bench rear seat 46 and the first rear center console 70 are attached to the vehicle body 20. In attaching the components, the first rear center console 70 is set to extend rearward from the rear end of the front center console 60 and protrude upward from the intermediate floor 34. In this manner, the vehicle 10 with a bench rear seat is complete.

When the processing advances to step S7, the separate rear seats 146 and the second rear center console 170 are attached to the vehicle body 20. In attaching the components, the second rear center console 170 is set to extend rearward from the rear end of the front center console 60 and protrude upward from the intermediate floor 34. In this manner, the vehicle 10 with separate rear seats is complete.

The steps are performed in any order. For example, steps S1, S2, and S3 for preparing the components may be performed in any order or at the same time.

After determining whether the vehicle is to be equipped with a bench sheet or separate seats, step S4 of assembling the common components together and subsequent step S6 or S7 may be performed. Assembling the common components and assembling the selective components may be performed at the same time or in sequence.

The method for manufacturing the vehicles 10 and 110 includes preparing, as the selective component set, the first set and the second set. The first set includes the bench rear seat 46 including the bench seat bottom 46a and the first rear center console 70. The second set includes the separate rear seats 146 including the right rear seat 146R and the left rear seat 146L and the second rear center console 170. The first rear center console 70 for the bench rear seat 46 and the second rear center console 170 for the separate rear seats 146 are thus prepared. This allows easy replacement of the rear center console 70 or 170 based on the type of the rear seat 46 or 146, separately from the front center console 60. The console replacement can be performed easily. For example, the first rear center console 70 that is less tall may be used to allow the occupant to easily cross over the rear center console 70. This structure is suitable for the bench rear seat 46. The rear center console 170 that is taller may be used to allow the occupant to easily place objects. This structure is suitable for the separate rear seats 146.

The components described in the above embodiments and modifications may be combined as appropriate unless any contradiction arises.

### Appendix

Aspects of the present disclosure are provided below.

A vehicle according to a first aspect includes a vehicle body, a front seat supported by the vehicle body, a rear seat supported by the vehicle body rearward from the front seat, a front center console, and a rear center console separate from the front center console and extending rearward from a rear end of the front center console. The vehicle body includes an intermediate floor located between the front seat and the rear seat in a front-rear direction. The rear center console protrudes upward from the intermediate floor and extends rearward from a position frontward from a middle position of the intermediate floor in the front-rear direction.

In this vehicle, the rear center console extends rearward from a position frontward from the middle position of the intermediate floor in the front-rear direction. The front center console and the rear center console can thus be easily replaced separately. The console replacement can be performed easily. For example, the rear center console that is less tall may be used to allow the occupant to easily cross over the rear center console. The rear center console that is taller may be used to allow the occupant to easily place objects.

A vehicle according to a second aspect is the vehicle according to the first aspect in which the front seat may include a seat bottom and a backrest. A boundary between the front center console and the rear center console may at least partially overlap the backrest as viewed in a width direction of the vehicle.

In this case, the rear center console can be easily extended in the front-rear direction on the intermediate floor. Such a rear center console is easily replaceable.

A vehicle according to a third aspect is the vehicle according to the first aspect or the second aspect in which the rear center console may include a storage defining a storage space.

The rear center console thus provides the storage space easily accessible to the users of the rear seat.

A vehicle according to a fourth aspect is the vehicle according to any one of the first to third aspects in which the rear seat may include a bench seat bottom having a bench seat surface extending in a width direction of the vehicle. The rear center console may extend under the bench seat bottom to avoid extending on the bench seat surface.

This allows effective use of the seat surface of the bench seat bottom.

A vehicle according to a fifth aspect is the vehicle according to the fourth aspect in which the rear center console may have a rear end located frontward from a rear end of the bench seat bottom.

This allows the rear center console to be easily mounted on the vehicle.

A vehicle according to a sixth aspect is the vehicle according to the fourth aspect or the fifth aspect in which the vehicle may further include a seatbelt retractor located on an imagery rearward extension from the rear center console.

In this structure, the rear center console is replaced to easily allow installation or non-installation of a rear seat center-seatbelt retractor.

A vehicle according to a seventh aspect is the vehicle according to any one of the fourth to sixth aspects in which the rear center console may include a console body having a rear console surface extending in the front-rear direction between the front seat and the rear seat in the front-rear direction. The rear console surface may be located lower than the bench seat surface.

In this case, the users of the rear seat can easily place their feet on the rear center console or cross over to the left or right of the rear center console.

A vehicle according to an eighth aspect is the vehicle according to the seventh aspect in which the rear center console may include a storage separate from the console body. The storage may define a storage space and protrude upward and rearward from a front portion of the console body.

In this case, a larger storage space may be easily provided at a higher position than the console body.

A vehicle according to a ninth aspect is the vehicle according to any one of the first to third aspects in which the rear seat may include a right rear seat and a left rear seat. The rear center console may extend in the front-rear direction between the right rear seat and the left rear seat.

The rear center console thus separates the right rear seat and the left rear seat from each other.

A vehicle according to a tenth aspect is the vehicle according to the ninth aspect in which the vehicle body may include a back panel located behind the rear seat. The back panel may have an opening facing frontward between the right rear seat and the left rear seat. The rear center console may close the opening.

In this case, the rear center console may be replaced to easily allow installation or non-installation of equipment that uses the opening in the back panel.

A vehicle according to an eleventh aspect is the vehicle according to any one of the first to tenth aspects in which a space in the front center console may be separate from a space in the rear center console. The front center console may receive a tube through which a fuel component passes. The rear center console may have an electrical component mounted on the rear center console.

This separates the space in which the tube for passage of fuel components is located from the section in which the electrical component is located.

A vehicle according to a twelfth aspect is the vehicle according to any one of the first to eleventh aspects in which the vehicle body may include an under-console frame extending in the front-rear direction between the front seat and the rear seat in the front-rear direction and under the rear center console. The under-console frame may be recessed downward in an area including the middle position of the intermediate floor in the front-rear direction.

In this case, the rear center console can be easily lowered, or the storage space in the rear center console can be easily enlarged.

A vehicle according to a thirteenth aspect is the vehicle according to any one of the first to twelfth aspects in which the vehicle may further include a front-seat wire guided from under the rear center console to the rear center console and extending out of the rear center console toward the front seat through a boundary between the rear center console and the front center console.

This allows the front-seat wire to be easily routed from the rear center console to the front seat.

A vehicle according to a fourteenth aspect is the vehicle according to any one of the first to thirteenth aspects in which the vehicle may further include a brake lever supported pivotally by a support shaft located in the front center console, and a cover. The front center console may have a brake slot with a height changing along length. The brake lever may protrude out of the front center console through the brake slot and may be supported pivotally. The cover may extend upward from the brake lever along the brake slot.

This reduces entry of foreign matter into the front center console through the brake slot.

A vehicle according to a fifteenth aspect is the vehicle according to any one of the first to fourteenth aspects in which the vehicle may further include a rear seat right-seatbelt retractor, and a rear seat left-seatbelt retractor. The vehicle body may include an under-rear seat frame including a portion extending rearward from under the rear seat at a middle position of the rear seat in a width direction of the vehicle. The rear seat right-seatbelt retractor may be located on a right of the under-rear seat frame. The rear seat left-seatbelt retractor may be located on a left of the under-rear seat frame. At least part of the rear seat right-seatbelt retractor and at least part of the rear seat left-seatbelt retractor may overlap the under-rear seat frame as viewed in the width direction of the vehicle.

In this case, at least part of the rear seat right-seatbelt retractor and at least part of the rear seat left-seatbelt retractor overlap the under-rear seat frame as viewed in the width direction of the vehicle. This increases the flexibility in the height position of the rear seat. For example, the rear seat is installed at a lowest possible position. The rear seat right-seatbelt retractor and the rear seat left-seatbelt retractor are located on the right or left of the under-rear seat frame under the rear seat. This easily increases the length of the seatbelt extended from each seatbelt retractor.

A vehicle according to a sixteenth aspect is the vehicle according to the fifteenth aspect in which the vehicle may further include a rear seat center-seatbelt retractor located behind the rear seat.

When the rear seat center-seatbelt retractor is included, the rear seat center-seatbelt retractor is located behind the rear seat. This increases the flexibility in the height position of the rear seat.

A method for manufacturing a vehicle according to a seventeenth aspect includes preparing a vehicle body including an intermediate floor, a front seat, and a front center console as common components, and preparing a first set and a second set as selective component sets. The first set includes a bench rear seat including a bench seat bottom and a first rear center console. The second set includes separate rear seats including a right rear seat and a left rear seat and a second rear center console. The method includes attaching the front seat, the front center console, the bench rear seat, and the first rear center console to the vehicle body to cause the first rear center console to extend rearward from a rear end of the front center console and to protrude upward from the intermediate floor to manufacture a vehicle with a rear bench seat, and attaching the front seat, the front center console, the separate rear seats, and the second rear center console to the vehicle body to cause the second rear center console to extend rearward from the rear end of the front center console and to protrude upward from the intermediate floor to manufacture a vehicle with rear separate seats.

This method for manufacturing the vehicle includes preparing, as the selective component sets, the first set and the second set. The first set includes the bench rear seat including the bench seat bottom and the first rear center console. The second set includes the separate rear seats including the right rear seat and the left rear seat and the second rear center console. The first rear center console for the bench rear seat including the bench seat bottom and the second rear center console for the separate rear seats can be prepared. This allows easy replacement of the rear center console based on the type of the rear seat, separately from the front center console. The console replacement can thus be performed easily. For example, the first rear center console that is less tall may be used to allow the occupant to easily cross over the rear center console. This structure is suitable for a bench rear seat. The rear center console that is taller may be used to allow the occupant to easily place objects. This structure is suitable for separate rear seats.

The foregoing discussion is illustrative in all respects, and the invention is not limited to the above structures. Numerous modifications that are not described above may be implemented without deviating from the scope of the present invention.

What is claimed is:

1. A vehicle, comprising:
a vehicle body;
a front seat supported by the vehicle body;
a rear seat supported by the vehicle body rearward from the front seat;
a front center console; and
a rear center console separate from the front center console and extending rearward from a rear end of the front center console,
wherein the vehicle body includes an intermediate floor located between the front seat and the rear seat in a front-rear direction, and
the rear center console protrudes upward from the intermediate floor and extends rearward from a position frontward from a middle position of the intermediate floor in the front-rear direction.

2. The vehicle according to claim 1, wherein
the front seat includes a seat bottom and a backrest, and
a boundary between the front center console and the rear center console at least partially overlaps the backrest as viewed in a width direction of the vehicle.

3. The vehicle according to claim 1, wherein
the rear center console includes a storage defining a storage space.

4. The vehicle according to claim 1, wherein
the rear seat includes a bench seat bottom having a bench seat surface extending in a width direction of the vehicle, and
the rear center console extends under the bench seat bottom to avoid extending on the bench seat surface.

5. The vehicle according to claim 4, wherein
the rear center console has a rear end located frontward from a rear end of the bench seat bottom.

6. The vehicle according to claim 4, further comprising:
a seatbelt retractor located on an imagery rearward extension from the rear center console.

7. The vehicle according to claim 4, wherein
the rear center console includes a console body having a rear console surface extending in the front-rear direction between the front seat and the rear seat in the front-rear direction, and
the rear console surface is located lower than the bench seat surface.

8. The vehicle according to claim 7, wherein
the rear center console includes a storage separate from the console body, and
the storage defines a storage space, and protrudes upward and rearward from a front portion of the console body.

9. The vehicle according to claim 1, wherein
the rear seat includes a right rear seat and a left rear seat, and
the rear center console extends in the front-rear direction between the right rear seat and the left rear seat.

10. The vehicle according to claim 9, wherein
the vehicle body includes a back panel located behind the rear seat,
the back panel has an opening facing frontward between the right rear seat and the left rear seat, and
the rear center console closes the opening.

11. The vehicle according to claim 1, wherein
a space in the front center console is separate from a space in the rear center console,
the front center console receives a tube through which a fuel component passes, and
the rear center console has an electrical component mounted on the rear center console.

12. The vehicle according to claim 1, wherein
the vehicle body includes an under-console frame extending in the front-rear direction between the front seat and the rear seat in the front-rear direction and under the rear center console, and
the under-console frame is recessed downward in an area including the middle position of the intermediate floor in the front-rear direction.

13. The vehicle according to claim 1, further comprising:
a front-seat wire guided from under the rear center console to the rear center console and extending out of the rear center console toward the front seat through a boundary between the rear center console and the front center console.

14. The vehicle according to claim 1, further comprising:
a brake lever supported pivotally by a support shaft located in the front center console; and
a cover,
wherein the front center console has a brake slot with a height changing along length,
the brake lever protrudes out of the front center console through the brake slot and is supported pivotally, and
the cover extends upward from the brake lever along the brake slot.

15. The vehicle according to claim 1, further comprising:
a rear seat right-seatbelt retractor; and
a rear seat left-seatbelt retractor,
wherein the vehicle body includes an under-rear seat frame including a portion extending rearward from under the rear seat at a middle position of the rear seat in a width direction of the vehicle,
the rear seat right-seatbelt retractor is located on a right of the under-rear seat frame,
the rear seat left-seatbelt retractor is located on a left of the under-rear seat frame, and
at least part of the rear seat right-seatbelt retractor and at least part of the rear seat left-seatbelt retractor overlap the under-rear seat frame as viewed in the width direction of the vehicle.

16. The vehicle according to claim 15, further comprising:
a rear seat center-seatbelt retractor located behind the rear seat.
